(19) United States
(12) Patent Application Publication
(10) Pub. No.: US 2005/0245285 A1
(43) Pub. Date: Nov. 3, 2005

(54) Wireless communication system and method of operating a wireless communication system

(75) Inventors: Simon Reza Saunders, Storrington (GB); Vasileios Nikolopoulos, Kalamata (GR)

Correspondence Address: LEYDIG VOIT & MAYER, LTD, 700 THIRTEENTH ST. NW, SUITE 300, WASHINGTON, DC, 20005-3960, US

(73) Assignee: University of Surrey, Surrey (GB)

(21) Appl. No.: 10/524,491

(22) PCT Filed: Jul. 29, 2003
(86) PCT No.: PCT/GB03/03213

§ 371 Date: May 27, 2005

(30) Foreign Application Priority Data
Aug. 14, 2002 (GB) 0218906.6

(51) Int. Cl. H04M 1/00

(52) U.S. Cl. 455/562.1; 455/425

(57) ABSTRACT

A wireless communication system includes a distributed antenna arrangement having a plurality of antenna elements arranged in groups and at least one mobile station including a RAKE reciever for combining received signals produced by the antenna elements. The antenna elements producing the strongest antenna signals are assigned to different groups and the antenna signal produced by the different groups of antenna elements are subjected to preset relative delays enabling the antenna signals to be coherently combined.

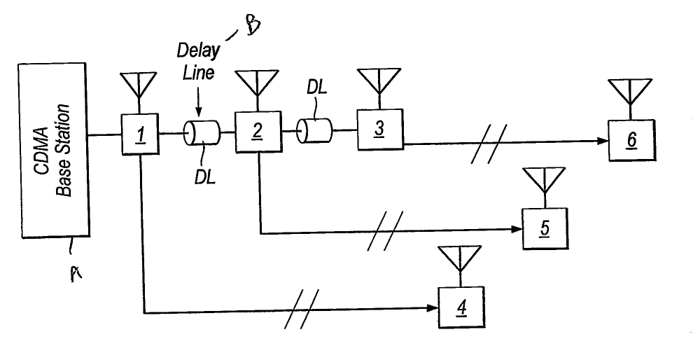

This invention relates to a wireless communication system and a method of operating a wireless communication system.

The invention concerns wireless communication systems having distributed antenna arrangements as may be deployed, for example, to provide coverage in an in-building environment, such as an office environment.

In order to enhance the capacity of an in-building distributed antenna arrangement it has been proposed that a time delay element be inserted between adjacent nodes created by individual antenna elements of the distributed antenna arrangement—see, for example, “A CDMA Distributed Antenna System for in-building personal communication service” by H. H. Xia et al, IEEE Journal on Selected Areas in Communications, Vol. 14, No. 4, pp 644-650, May 1996. Such delay reduces self interference or fading when antenna signals produced by different antenna elements are combined in the RAKE receiver of a mobile station. Typically, the delay must be greater than 1/B, where B is the W-CDMA bandwidth, to enable the RAKE receiver to form a coherent combination of the antenna signals received from individual antenna elements of the distributed antenna arrangement.

Typically, a mobile station includes a RAKE receiver having only a small number of RAKE fingers (typically 3), and this gives rise to a problem when the distributed antenna arrangement has a greater number of antenna elements. In this case, the antenna signals received at the mobile station can create self interference instead of contributing to the desired signal.

With a view to alleviating the problem it is proposed to arrange the antenna elements of a distributed antenna arrangement in groups, with the antenna elements producing the strongest antenna signals at a mobile station being assigned to different groups.

According to one aspect of the invention there is provided a wireless communication system including a mobile station and a base station having a distributed antenna arrangement comprising a plurality of antenna elements for producing antenna signals across an area of coverage of the distributed antenna arrangement, wherein said antenna elements are arranged in groups, antenna elements producing the strongest antenna signals at the mobile station within at least part of said area of covereage are assigned to different said groups and antenna signals produced by the different groups of antenna elements are subjected to preset relative delays enabling the antenna signals to be combined substantially coherently in the mobile station.

In a preferred embodiment, said mobile station includes a RAKE receiver for combining the antenna signals, the RAKE receiver having N RAKE fingers, where N is an integer equal to the number of said groups.

According to another aspect of the invention there is provided a method of operating a wireless communication system including a mobile station and a base station having a distributed antenna arrangement comprising a plurality of antenna elements for producing antenna signals across an area of coverage of the distributed antenna arrangement, the method including assigning antenna elements producing the strongest antenna signals at the mobile station, within at least part of said area of coverage, to different said groups, and subjecting antenna signals produced by the different groups of antenna elements to preset relative delays enabling the antenna signals to be combined substantially coherently in the mobile station.

An embodiment of the invention is now described, by way of example only, with reference to the sole FIGURE of the drawings which shows a schematic representation of a wireless communication system having a distributed antenna arrangement of which the individual antenna elements are assigned to different groups with a view to reducing self interference of antenna signals received at a mobile station.

In this embodiment, the distributed antenna arrangement has six antenna elements (1-6). The antenna elements are arranged in three groups commensurate with the number of RAKE fingers in the RAKE receiver of a system mobile station (not shown in the drawing). Thus, antenna elements 1,4 form a first group, antenna elements 2,5 form a second group and antenna elements 3,6 form a third group.

Antenna signals produced by antenna elements of the same group are all subjected to the same preset delay created by an associated delay line represented schematically by the elements DL in the drawing.

In this particular embodiment, the antenna signals produced by antenna elements 3,6 of the third group are subjected to a larger preset delay than the antenna signals produced by antenna elements 2,5 of the second group, and the antenna signals produced by antenna elements 1,4 of the first group are not subjected to any preset delay. In this way, antenna signals produced by the different groups of antenna elements are subjected to preset relative delays, typically greater than 1/B, where B is the system bandwidth, and can be combined substantially coherently in the mobile station, without significant self interference.

The antenna elements producing the three strongest antenna signals are assigned to different groups. In this particular example, it is assumed that the mobile station is relatively close to antenna elements 1,2,3. Therefore, these antenna elements have the smallest path losses to the mobile station and produce the strongest antenna signals which are combined substantially coherently in the RAKE receiver of the mobile station due to the preset relative delays imposed on the antenna signals produced by the different groups of antenna elements. In view of this, it is likely that the remaining antenna elements 4,5,6 of the groups will be located further away from the mobile station. These more distant antenna elements produce much weaker signals than the closer antenna elements 1,2,3 and so have no significant adverse impact on the coherence of antenna signals processed by the RAKE receiver in the mobile station.

Alternatively, the mobile station might be closer to antenna elements 4,5,6 which would then produce the strongest antenna signals. In this case, antenna elements 1,2,3 would be more distant, producing weaker antenna signals. Nevertheless, the composition of the three groups and their preset relative delays remain unchanged.

In general, there is a high probability that antenna elements assigned to different groups will produce the strongest antenna signals at all locations across the entire coverage area of the distributed antenna arrangement. However, it will be appreciated that for some distributed antenna arrangements there may be isolated regions within the coverage area for which this is not the case.

1. A wireless communication system including a mobile station and a base station having a distributed antenna arrangement comprising a plurality of antenna elements for producing antenna signals across an area of coverage of the distributed antenna arrangement, wherein said antenna elements are arranged in groups, antenna elements producing the strongest antenna signals at the mobile station, within at least part of said area of coverage, are assigned to different said groups and antenna signals produced by the different groups of antenna elements are subjected to preset relative delays enabling the antenna signals to be combined substantially coherently in the mobile station.

2. The wireless communication system as claimed in claim 1 wherein said mobile station includes a RAKE receiver having N RAICE lingers, where N is an integer equal to the number of said groups.

3. The wireless communication system as claimed in claim 2 wherein N is 3.

4. The wireless communication system as claimed in claim 1 wherein antenna signals produced by the antenna elements of one of said groups are not subjected to any preset delay.

5. The wireless communication system as claimed in claim 1 including at least one delay line, wherein the or each delay line subjects antenna signals produced by all the antenna elements of a respective group to the same preset delay.

6. A method of operating a wireless communication system including a mobile station and a base station having a distributed antenna arrangement comprising a plurality of antenna elements for producing antenna signals across an area of coverage of the distributed antenna arrangement, the method including assigning antenna elements producing the strongest antenna signals at the mobile station, within at least part of said area of coverage, to different said groups, and subjecting antenna signals produced by the different groups of antenna elements to preset relative delays enabling the antenna signals to be combined substantially coherently in the mobile station.

7. The method according to claim 6 wherein the antenna signals produced by the antenna elements of one of the groups are not subjected to any preset delay.

8. (canceled)

9. (canceled)

10. The wireless communication system as claimed in claim 2 wherein antenna signals produced by the antenna elements of one of said groups are not subjected to any present delay.

11. The wireless communication system as claimed in claim 3 wherein antenna signals produced by the antenna elements of one of said groups are not subjected to any present delay.

12. The wireless communication system as claimed in claim 2 including at least one delay line, wherein the or each delay line subjects antenna signals produced by all the antenna elements of a respective group to the same present delay.

13. The wireless communication system as claimed in claim 3 including at least one delay line, wherein the or each delay line subjects antenna signals produced by all the antenna elements of a respective group to the same present delay.

14. The wireless communication system as claimed in claim 4 including at least one delay line, wherein the or each delay line subjects antenna signals produced by all the antenna elements of a respective group to the same present delay.
